(19) United States
(12) Patent Application Publication
(10) Pub. No.: US 2006/0253440 A1
(43) Pub. Date: Nov. 9, 2006

(54) ELIMINATING FILE REDUNDANCY IN A COMPUTER FILESYSTEM AND ESTABLISHING MATCH PERMISSION IN A COMPUTER FILESYSTEM

(75) Inventors: Benjamin C. Reed, Morgan Hill, CA (US); Mark A. Smith, Los Gatos, CA (US)

Correspondence Address: INTERNATIONAL BUSINESS MACHINES CORPORATION;INTELLECTUAL PROPERTY LAW, 650 HARRY ROAD, SAN JOSE, CA, 95120, US

(73) Assignee: IBM CONFIDENTIAL, Armonk, NY (US)

(21) Appl. No.: 10/908,375

(22) Filed: May 9, 2005

(51) Int. Cl. G06F 7/00

(52) U.S. Cl. 707/7

(57) ABSTRACT

The present invention provides a method and system of eliminating file redundancy for at least one computer file in a computer filesystem and a method and system of establishing match permission for at least one computer file in a computer filesystem. The present invention provides a method and system of eliminating file redundancy for at least one computer file in a computer filesystem. In an exemplary embodiment the method and system eliminates file redundancy for at least one computer file in a computer filesystem via implicit file unification. In an exemplary embodiment the method and system eliminates file redundancy for at least one computer file in a computer filesystem via explicit file unification. In an exemplary embodiment the method and system eliminates file redundancy in a computer filesystem via file identifier file unification.

### FIELD OF THE INVENTION

The present invention relates to computer filesystems, and particularly relates to a method and system of eliminating file redundancy for at least one computer file in a computer filesystem and a method and system of establishing match permission for at least one computer file in a computer filesystem.

### BACKGROUND OF THE INVENTION

Redundant Files Internal to an Existing Computer Filesystem

Computer filesystems may use a great deal of computer storage to store large collections of computer files. In particular, an existing computer filesystem may contain redundant files. As a result, such a filesystem would use computer storage for redundant files.

### PRIOR ART SYSTEMS

Many prior art systems attempt to eliminate redundant files on an existing filesystem. These prior art systems attempt to reduce the amount of data bytes in the filesystem while still maintaining full data integrity (i.e. no loss of information) in the filesystem. Many of these prior art systems are described in IBM Research Report—Redundancy Elimination within Large Collections of Files by Purushottam Kulkarni, Fred Douglis, Jason LaVoie, and John M. Tracey, found at http://www.research.ibm.com/drat/index.html. However, these prior art systems have several problems.

Single File Compression

In a first prior art approach, as shown in prior art FIG. 1A, a first prior art system uses single file compression to eliminate redundancy internal to a file in a filesystem. Specifically, the first prior art system (1) analyzes the bytes in the file and (2) determines a more efficient way to store those bytes. The process of the first prior art system is reversible in order to reconstruct the original data. However, the first prior art system (a) can be very expensive in terms of computational effort and (b) does not eliminate redundancy across multiple files.

Tar+Compression

In a second prior art approach, as shown in prior art FIG. 1B, a second prior art system uses a tar+compress approach to eliminate redundancy internal to a plurality of files in a filesystem. Specifically, the second prior art system (1) runs a tar (i.e. a tape archive utility) on a plurality of files, thereby bundling the plurality of files into a single file and (2) compresses the single file. The second prior art system can also eliminate redundancy across multiple files. However, in the second prior art system, (a) adding and removing files from the tar+compress and (b) modifying the contents of the tar+compress would be prohibitively expensive when used for an entire filesystem.

Single Instance Store (SiS)

In a third prior art approach, as shown in prior art FIG. 1C, a third prior art system uses Microsoft Corporation's Single Instance Store (SiS) to attempt to eliminate redundant files on an existing filesystem. SiS is described at http://db.usenix.org/publications/library/proceedings/usenix-win2000/full_papers/bolosky/bolosky.pdf. However, the third prior art system fails to compute a hash that can be used to determine file sameness among files. Specifically, the third prior art system attempts to perform unify files based on file identifiers as opposed to unifying files on hash values of the files. In the third prior art system, if a new file is added to a filesystem, the third prior art system (a) looks at every file on the system until it finds a file with a similar hash and (b) then unifies those two files, an expensive operation. Therefore, for example, if the third prior art system attempts to unifying two files, the third prior art system must re-read the two files in order to ensure that the two files are the same. In addition, by using copy-on-close semantics, the third prior art system suffers problems with memory mapping.

Transmitting and Storing Redundant Files

Computer network filesystems may use a great deal of bandwidth to move large collections of computer files from a client computer system to server computer system that includes a computer filesystem. In particular, a network filesystem may attempt to transmit redundant files. As a result, such a network filesystem would be using bandwidth for redundant files.

Prior Art Systems

Many prior art systems attempt to reduce the amount of data bytes which must be transmitted to and stored on a storage system while still maintaining full data integrity in the filesystem. Many of these prior art systems are described in IBM Research Report—Redundancy Elimination within Large Collections of Files by Purushottam Kulkarni, Fred Douglis, Jason LaVoie, and John M. Tracey, found at http://www.research.ibm.com/drat/index.html. However, these prior art systems have several problems.

Single File Compression

The first prior art approach shown in prior art FIG. 1A also attempts to reduce the amount of data bytes which must be transmitted to and stored on a storage system while still maintaining full data integrity in the filesystem. The first prior art approach suffers from similar problems when attempting to reduce the amount of data bytes which must be transmitted to and stored on a storage system.

Tar+Compression

The second prior art approach shown in prior art FIG. 1B also attempts to reduce the amount of data bytes which must be transmitted to and stored on a storage system while still maintaining full data integrity in the filesystem. The second prior art approach suffers from similar problems when attempting to reduce the amount of data bytes which must be transmitted to and stored on a storage system.

Single Instance Store (SiS)

The third prior art approach shown in prior art FIG. 1C also attempts to reduce the amount of data bytes which must be transmitted to and stored on a storage system while still maintaining full data integrity in the filesystem. The third prior art approach suffers from similar problems when attempting to reduce the amount of data bytes which must be transmitted to and stored on a storage system. Moreover, the third prior art approach does not unify files over a computer network, and, thus, the third prior art system cannot obviate redundant file transfers over a computer network.

Redundancy Elimination at Write/Send Time

In a fourth prior art approach, as shown in prior art FIG. 1D, a fourth prior art system attempts to prevent the writing or sending of redundant data across a computer network and into a filesystem. The fourth prior art system (1) uses block-level duplicate detection using fixed-size and content-defined chunks and (2) uses checksums/hashes. The fourth prior art system can reduce the transmission of duplicate data. However, the fourth prior art system suffers from limitations due to access control mechanisms on the filesystem. For example, in the fourth prior art system, matching a checksum or a hash to checksums or hashes of data on a filesystem can leak information about data on that filesystem. In addition, fourth prior art system fails to address the problem of duplicate data already on a filesystem which may get onto the filesystem due to adherence to those access limitations.

In addition, in the fourth prior art system, if redundant data is identified and a send of the date is obviated, often the redundant bytes are written to disk out of filesystem cache (e.g. in Low Bandwidth File System (LBFS), described at http://www.fs.net/lbfs). Also, fourth prior system operates at write/send time, which is not optimal for whole-file redundancy elimination.

Security Restrictions on Data Being Matched Against

The security restrictions on data that can be matched against are often too strong to allow for a hash compare. Without controlling access even to the hash of the data on a computer filesystem, information about the content of the data can be leaked. This security hole is explicated further in the following example. Consider a company whose mail servers use such a bandwidth reduction technique. The mail servers send out a computer file containing a form letter informing each of their employees about information to that employee. For two employees, the two computer files containing the form letter would be substantially identical except for a few numbers. If two employees, employee A and employee B share the same mail server, employee A could figure out employee B's personal information by slightly modifying the form letter and then issuing repeated redundancy elimination requests to the filesystem until it responds with “hash found”. Employee A could then gain access to employee B's personal information contained in employee B's form letter. For this reason, bandwidth reduction techniques must be subject to Access Control List (ACL) information on target files. Thus, a certain level of security is needed to protect against this security hole.

Prior Art Systems

Prior art systems attempt to protect against this security hole with security restrictions.

Not Enforce Access Controls

In a fifth prior art approach, as shown in prior art FIG. 1E, a fifth prior art system does not enforce access controls on hash “match” requests. The fifth prior art system relies on the fact that it is difficult to correctly “guess” the content of another file. However, the fifth prior art system suffers from the security hole.

Grant Read Permission

In a sixth prior art approach, as shown in prior art FIG. 1F, a sixth prior art system requires that a file being matched against grant read permission to a user attempting to match the hash of the file. The sixth prior art approach closes the security hole. However, the sixth prior art approach imposes such a strong restriction that it requires much bandwidth when attempting to perform explicit file unification.

Therefore, a method and system of eliminating file redundancy for at least one computer file in a computer filesystem and a method and system of establishing match permission for at least one computer file in a computer filesystem are needed.

### SUMMARY OF THE INVENTION

The present invention provides a method and system of eliminating file redundancy for at least one computer file in a computer filesystem and a method and system of establishing match permission for at least one computer file in a computer filesystem. The present invention provides a method and system of eliminating file redundancy for at least one computer file in a computer filesystem. In an exemplary embodiment the method and system eliminates file redundancy for at least one computer file in a computer filesystem via implicit file unification. In an exemplary embodiment, the method and system of eliminating file redundancy for at least one computer file in a computer filesystem include (1) maintaining a catalogue of the hash value of the data section of the at least one file and a cold queue, (2) if a cold file that exits the cold queue is not added to the catalogue and if a found file that has a hash value equal to the hash value of the cold file is a member of a unification, adding the cold file to the unification, and (3) if a cold file that exits the cold queue is not added to the catalogue and if a found file that has a hash value equal to the hash value of the cold file is not a member of a unification, creating a new unification including the cold file and the found file.

In an exemplary embodiment, the maintaining includes (1) cataloguing each new file added to the filesystem by the hash value of the data section of the new file, (2) determining whether the new file has become cold according to a heuristic, (3) adding the new file that has become cold to the cold queue, wherein the cold queue comprises at least one cold file, (4) identifying whether each cold file exiting the cold queue is still cold according to the heuristic, thereby identifying a still cold file, (5) hashing the data section of the still cold file, and (6) if the hash value of the data section of the still cold file does not exist in the catalogue, adding the hash value of the data section of the still cold file to the catalogue. In an exemplary embodiment, the determining includes identifying that the new file has become cold when the new file is removed from the cache of the filesystem. In an exemplary embodiment, the determining includes identifying that the new file has become cold when the new file receives a write request on a page boundary and the write request is not page length.

In an exemplary embodiment, the adding includes (1) causing the cold file to reference the data section of the unification, (2) adding the unique identifier of the cold file to a list of files in the unification, and (3) deleting the data section of the cold file. In an exemplary embodiment, the creating includes (1) creating the new unification using the data section of the found file, (2) causing the cold file and the found file to reference the data section of the new unification, (3) adding the unique identifier of the cold file to a list of files in the new unification, (4) adding the unique identifier of the found file to the list of files, (5) deleting the data section of the cold file, and (6) deleting the data section of the found file.

In an exemplary embodiment, the present invention further includes (1) receiving a request to modify the data section of a target file that is a member of a unification, (2) copying out the contents of the data section of the unification, (3) removing the unique identifier of the target file from a list of files in the unification, and (4) if a reference to the unification via the target file is in the catalogue, replacing the reference with any other file in the list. In an exemplary embodiment, the present invention further includes (1) receiving a request to delete a target file that is a member of a unification, (2) removing the unique identifier of the target file from a list of files in the unification, and (3) if a reference to the unification via the target file is in the catalogue, replacing the reference with any other file in the list.

In an exemplary embodiment the method and system eliminates file redundancy for at least one computer file in a computer filesystem via explicit file unification. In an exemplary embodiment, the method and system of eliminating file redundancy for at least one computer file in a computer filesystem include (1) maintaining a catalogue of the hash value of the data section of the at least one file and a cold queue, (2) receiving at least one explicit file unification request, wherein the request includes a target hash value, (3) creating a new file, (4) if the target hash value does not exist in the catalogue, indicating that the new file has been created, (5) if the target hash value exists in the catalogue and a found file that has a hash value equal to the target hash value is a member of a unification, (a) checking for sufficient access to any member of the unification, (b) if sufficient access is not granted, indicating that the new file has been created, and (c) if sufficient access is granted, adding the new file to the unification, and (6) if the target hash value exists in the catalogue and a found file that has a hash value equal to the target hash value is not a member of a unification, (a) checking for sufficient access to the found file, (b) if sufficient access is not granted, indicating that the new file has been created, and (c) if sufficient access is granted, forming a new unification including the new file and the found file. In an exemplary embodiment, the adding further includes indicating successful unification. In an exemplary embodiment, the forming further includes indicating successful unification.

In an exemplary embodiment the method and system eliminates file redundancy in a computer filesystem via file identifier file unification. In an exemplary embodiment, the method and system of eliminating file redundancy in a computer filesystem include (1) receiving at least one explicit file unification request, wherein the request includes a special file identifier, (2) searching in the filesystem for a found file that has a file identifier equal to the special file identifier, (3) if the found file does not exist, indicating that the found file does not exist, and (4) if the found file exists, (a) checking for sufficient access to the found file, (b) if sufficient access is not granted, indicating that access to the found file is denied, and (c) if sufficient access is granted, (i) creating a new file, (ii) if the found file is a member of a unification, adding the new file to the unification and indicating successful unification, and (iii) if the found file is not a member of a unification, forming a new unification including the new file and the found file and indicating successful unification.

The present invention also provides a method and system of establishing match permission for at least one computer file in a computer filesystem. In an exemplary embodiment, the method and system include (1) granting a permission to match the data section of the file and (2) permitting a one-way, collision resistant hash of the data section of the file to be exposed based on the permission.

The present invention also provides a computer program product usable with a programmable computer having readable program code embodied therein of eliminating file redundancy for at least one computer file in a computer filesystem. In an exemplary embodiment, the computer program product includes (1) computer readable code for maintaining a catalogue of the hash value of the data section of the at least one file and a cold queue, (2) computer readable code for, if a cold file that exits the cold queue is not added to the catalogue and if a found file that has a hash value equal to the hash value of the cold file is a member of a unification, adding the cold file to the unification, and (3) computer readable code for, if a cold file that exits the cold queue is not added to the catalogue and if a found file that has a hash value equal to the hash value of the cold file is not a member of a unification, creating a new unification comprising the cold file and the found file.

In an exemplary embodiment, the computer readable code for maintaining includes (1) computer readable code for cataloguing each new file added to the filesystem by the hash value of the data section of the new file, (2) computer readable code for determining whether the new file has become cold according to a heuristic, (3) computer readable code for adding the new file that has become cold to the cold queue, wherein the cold queue comprises at least one cold file, (4) computer readable code for identifying whether each cold file exiting the cold queue is still cold according to the heuristic, thereby identifying a still cold file, (5) computer readable code for hashing the data section of the still cold file and (6) computer readable code for, if the hash value of the data section of the still cold file does not exist in the catalogue, adding the hash value of the data section of the still cold file to the catalogue.

### THE FIGURES

FIG. 1A is a flowchart of a prior art technique.

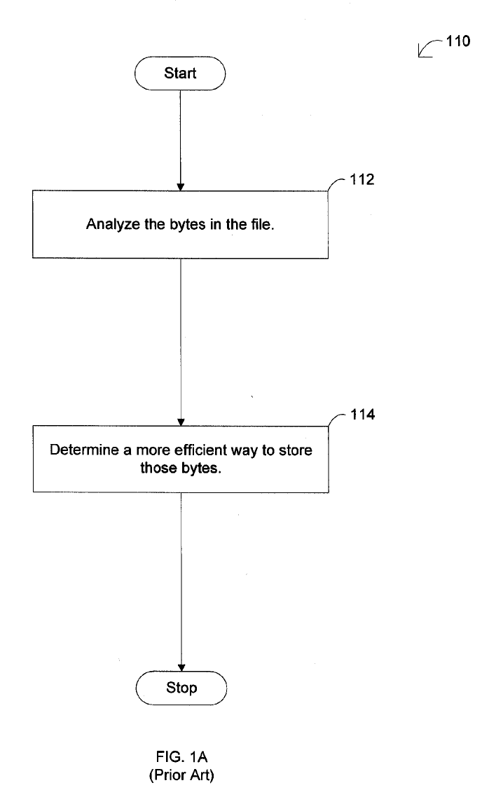

FIG. 1B is a flowchart of a prior art technique.

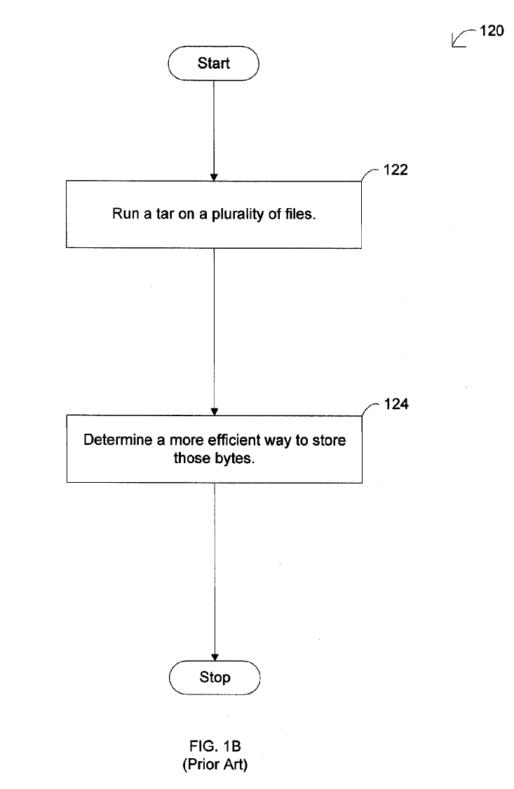

FIG. 1C is a flowchart of a prior art technique.

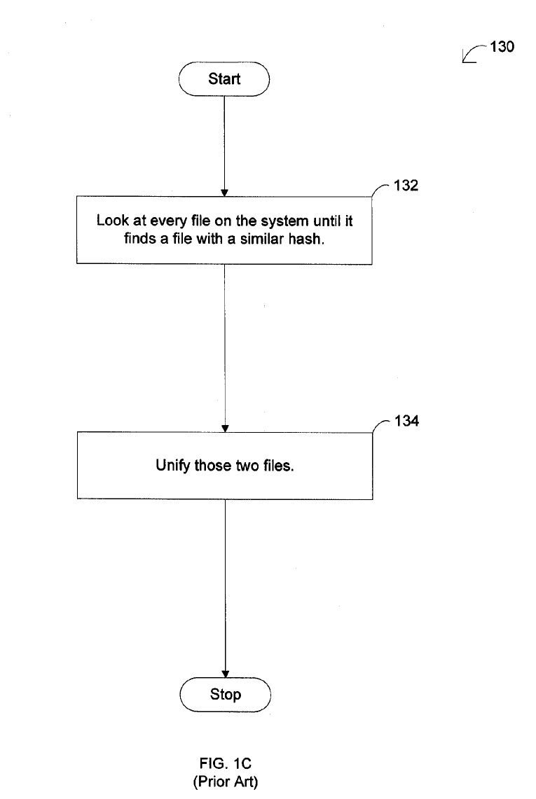

FIG. 1D is a flowchart of a prior art technique.

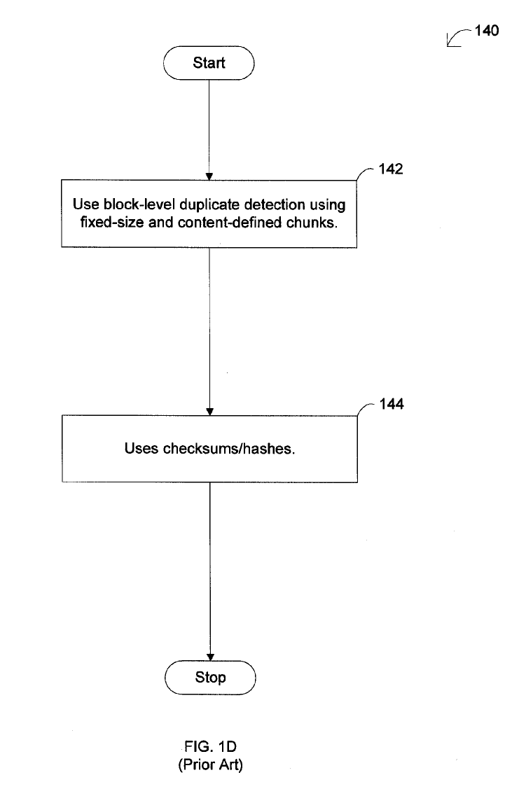

FIG. 1E is a flowchart of a prior art technique.

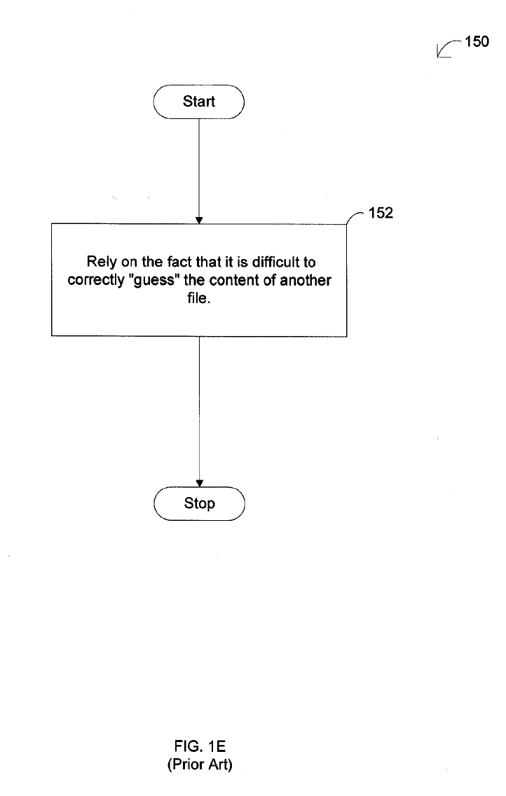

FIG. 1F is a flowchart of a prior art technique.

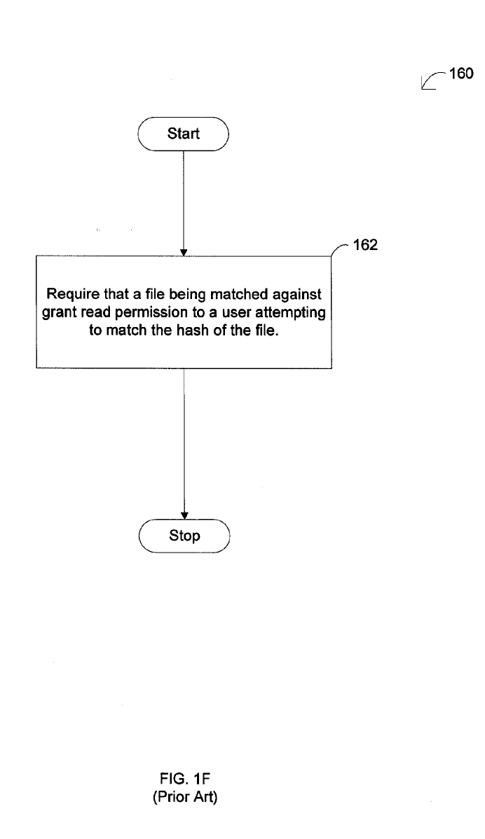

FIG. 2 is a flowchart in accordance with an exemplary embodiment of the present invention.

FIG. 3A is a flowchart of the maintaining step in accordance with an exemplary embodiment of the present invention.

FIG. 3B is a flowchart of the determining step in accordance with an exemplary embodiment of the present invention.

FIG. 3C is a flowchart of the determining step in accordance with an exemplary embodiment of the present invention.

FIG. 4 is a flowchart of the adding step in accordance with an exemplary embodiment of the present invention.

FIG. 5 is a flowchart of the creating step in accordance with an exemplary embodiment of the present invention.

FIG. 6A is a flowchart in accordance with a further embodiment of the present invention.

FIG. 6B is a flowchart in accordance with a further embodiment of the present invention.

FIG. 7 is a flowchart in accordance with an exemplary embodiment of the present invention.

FIG. 8A is a flowchart of the maintaining step in accordance with an exemplary embodiment of the present invention.

FIG. 8B is a flowchart of the determining step in accordance with an exemplary embodiment of the present invention.

FIG. 8C is a flowchart of the determining step in accordance with an exemplary embodiment of the present invention.

FIG. 9 is a flowchart of the adding step in accordance with an exemplary embodiment of the present invention.

FIG. 10 is a flowchart of the forming in accordance with an exemplary embodiment of the present invention.

FIG. 11A is a flowchart in accordance with a further embodiment of the present invention.

FIG. 11B is a flowchart in accordance with a further embodiment of the present invention.

FIG. 12A is a flowchart of the checking in accordance with an exemplary embodiment of the present invention.

FIG. 12B is a flowchart of the determining step in accordance with an exemplary embodiment of the present invention.

FIG. 13 is a flowchart in accordance with an exemplary embodiment of the present invention.

FIG. 14 is a flowchart of the adding step in accordance with an exemplary embodiment of the present invention.

FIG. 15 is a flowchart of the forming in accordance with an exemplary embodiment of the present invention.

FIG. 16A is a flowchart in accordance with a further embodiment of the present invention.

FIG. 16B is a flowchart in accordance with a further embodiment of the present invention.

FIG. 17A is a flowchart of the checking in accordance with an exemplary embodiment of the present invention.

FIG. 17B is a flowchart of the determining step in accordance with an exemplary embodiment of the present invention.

FIG. 18 is a flowchart in accordance with an exemplary embodiment of the present invention.

FIG. 19A is a flowchart in accordance with a further embodiment of the present invention.

FIG. 19B is a flowchart of the checking step in accordance with an exemplary embodiment of the present invention.

### DETAILED DESCRIPTION OF THE INVENTION

The present invention provides a method and system of eliminating file redundancy for at least one computer file in a computer filesystem and a method and system of establishing match permission for at least one computer file in a computer filesystem.

Eliminating File Redundancy

The present invention provides a method and system of eliminating file redundancy for at least one computer file in a computer filesystem.

Implicit File Unification

In an exemplary embodiment the method and system eliminates file redundancy for at least one computer file in a computer filesystem via implicit file unification. In an exemplary embodiment, the method and system of eliminating file redundancy for at least one computer file in a computer filesystem include (1) maintaining a catalogue of the hash value of the data section of the at least one file and a cold queue, (2) if a cold file that exits the cold queue is not added to the catalogue and if a found file that has a hash value equal to the hash value of the cold file is a member of a unification, adding the cold file to the unification, and (3) if a cold file that exits the cold queue is not added to the catalogue and if a found file that has a hash value equal to the hash value of the cold file is not a member of a unification, creating a new unification including the cold file and the found file.

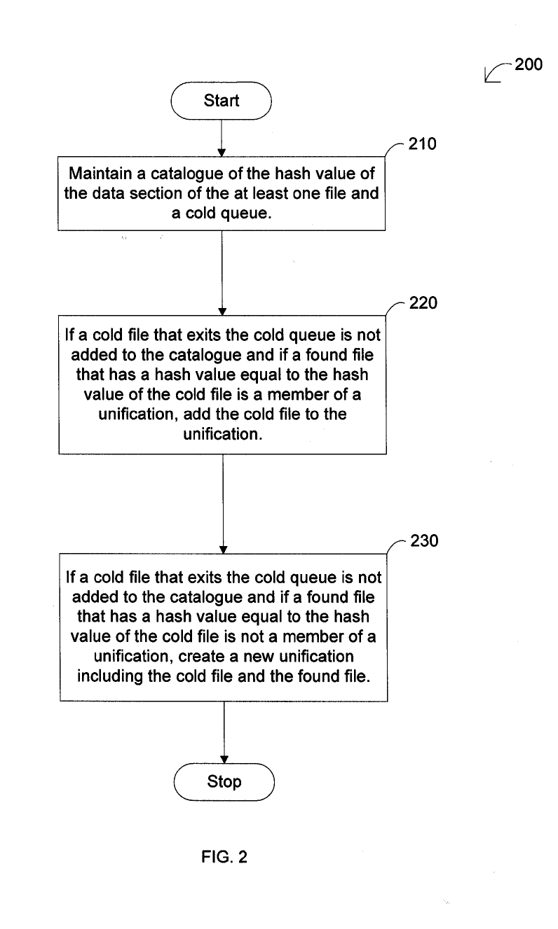

Referring to FIG. 2, in an exemplary embodiment, the present invention includes a step 210 of maintaining a catalogue of the hash value of the data section of the at least one file and a cold queue, a step 220 of, if a cold file that exits the cold queue is not added to the catalogue and if a found file that has a hash value equal to the hash value of the cold file is a member of a unification, adding the cold file to the unification, and a step 230 of, if a cold file that exits the cold queue is not added to the catalogue and if a found file that has a hash value equal to the hash value of the cold file is not a member of a unification, creating a new unification including the cold file and the found file.

Maintaining a Catalogue

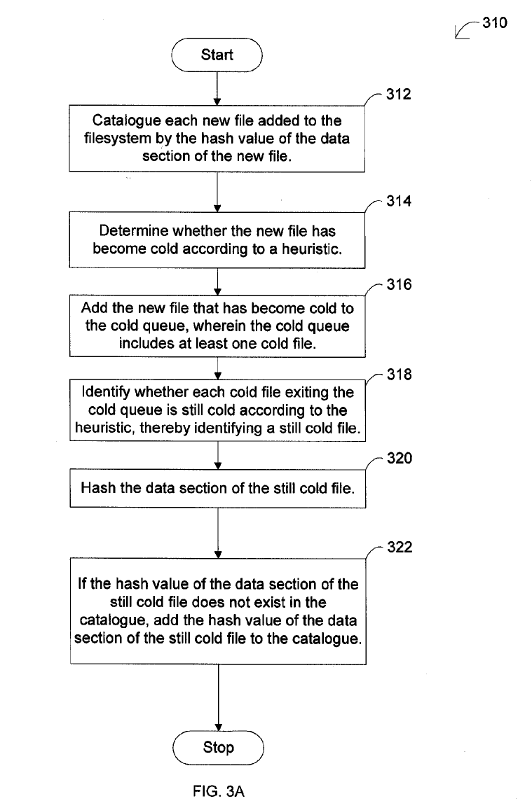

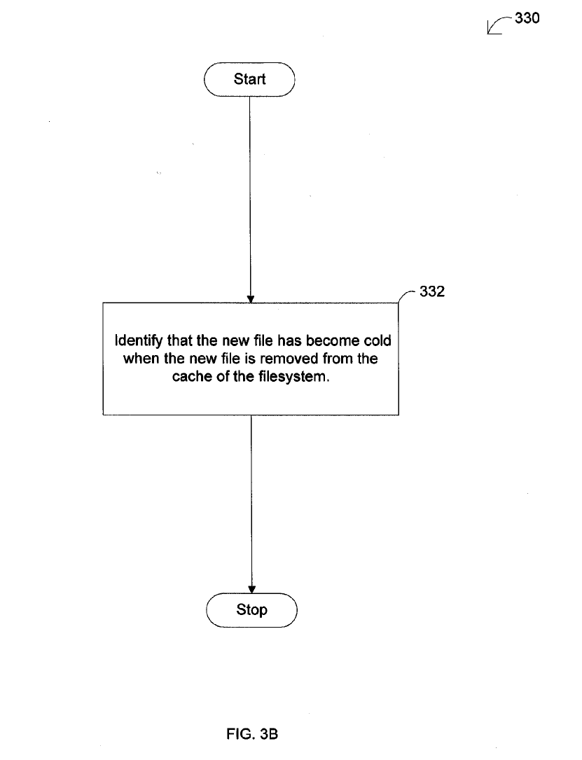

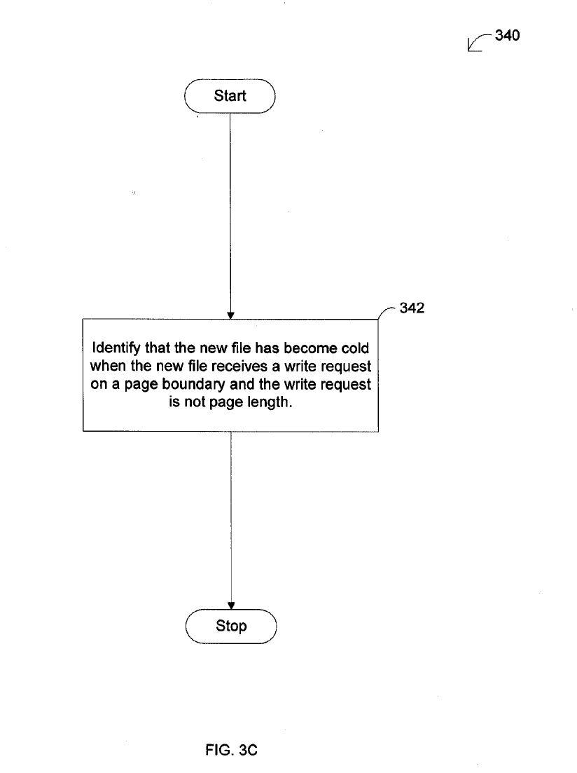

Referring next to FIG. 3A, in an exemplary embodiment, maintaining step 210 includes a step 312 of cataloguing each new file added to the filesystem by the hash value of the data section of the new file, a step 314 of determining whether the new file has become cold according to a heuristic, a step 316 of adding the new file that has become cold to the cold queue, wherein the cold queue includes at least one cold file, a step 318 of identifying whether each cold file exiting the cold queue is still cold according to the heuristic, thereby identifying a still cold file, a step 320 of hashing the data section of the still cold file, and a step 322 of, if the hash value of the data section of the still cold file does not exist in the catalogue, adding the hash value of the data section of the still cold file to the catalogue. Referring next to FIG. 3B, in an exemplary embodiment, determining step 314 includes a step 332 of identifying that the new file has become cold when the new file is removed from the cache of the filesystem. Referring next to FIG. 3C, in an exemplary embodiment, determining step 314 includes a 342 of identifying that the new file has become cold when the new file receives a write request on a page boundary and the write request is not page length.

Adding the Cold File

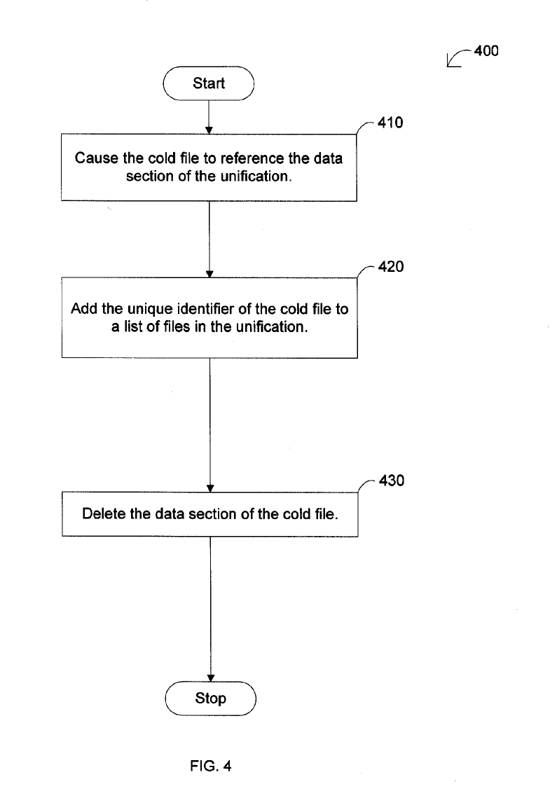

Referring next to FIG. 4, in an exemplary embodiment, adding step 220 includes a step 41 0 of causing the cold file to reference the data section of the unification, a step 420 of adding the unique identifier of the cold file to a list of files in the unification, and a step 430 of deleting the data section of the cold file.

Creating a New Unification

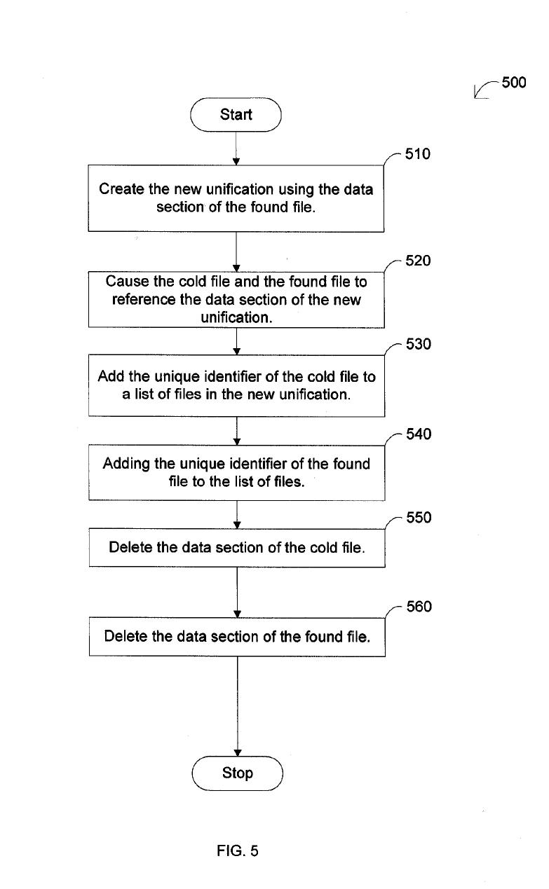

Referring next to FIG. 5, in an exemplary embodiment, creating step 230 includes a step 510 of creating the new unification using the data section of the found file, a step 520 of causing the cold file and the found file to reference the data section of the new unification, a step 530 of adding the unique identifier of the cold file to a list of files in the new unification, a step 540 of adding the unique identifier of the found file to the list of files, a step 550 of deleting the data section of the cold file, and a step 560 of deleting the data section of the found file.

Modifying the Data Section of a Target File

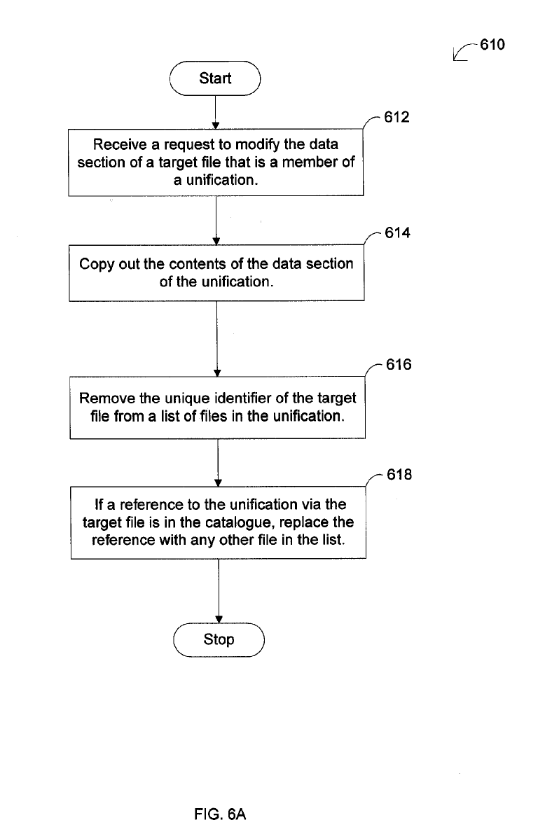

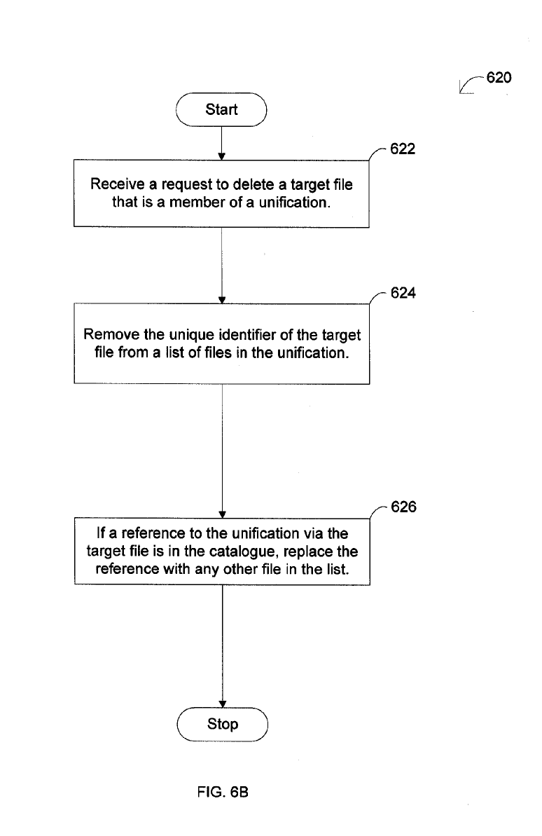

Referring next to FIG. 6A, in an exemplary embodiment, the present invention further includes a step 612 of receiving a request to modify the data section of a target file that is a member of a unification, a step 614 of copying out the contents of the data section of the unification, a step 616 of removing the unique identifier of the target file from a list of files in the unification, and a step 618 of, if a reference to the unification via the target file is in the catalogue, replacing the reference with any other file in the list.

Deleting a Target File

Referring next to FIG. 6B, in an exemplary embodiment, the present invention further includes a step 622 of receiving a request to delete a target file that is a member of a unification, a step 624 of removing the unique identifier of the target file from a list of files in the unification, and a step 626 of, if a reference to the unification via the target file is in the catalogue, replacing the reference with any other file in the list.

Explicit File Unification

In an exemplary embodiment the method and system eliminates file redundancy for at least one computer file in a computer filesystem via explicit file unification. In an exemplary embodiment, the method and system of eliminating file redundancy for at least one computer file in a computer filesystem include (1) maintaining a catalogue of the hash value of the data section of the at least one file and a cold queue, (2) receiving at least one explicit file unification request, wherein the request includes a target hash value, (3) creating a new file, (4) if the target hash value does not exist in the catalogue, indicating that the new file has been created, (5) if the target hash value exists in the catalogue and a found file that has a hash value equal to the target hash value is a member of a unification, (a) checking for sufficient access to any member of the unification, (b) if sufficient access is not granted, indicating that the new file has been created, and (c) if sufficient access is granted, adding the new file to the unification, and (6) if the target hash value exists in the catalogue and a found file that has a hash value equal to the target hash value is not a member of a unification, (a) checking for sufficient access to the found file, (b) if sufficient access is not granted, indicating that the new file has been created, and (c) if sufficient access is granted, forming a new unification including the new file and the found file. In an exemplary embodiment, the adding further includes indicating successful unification. In an exemplary embodiment, the forming further includes indicating successful unification.

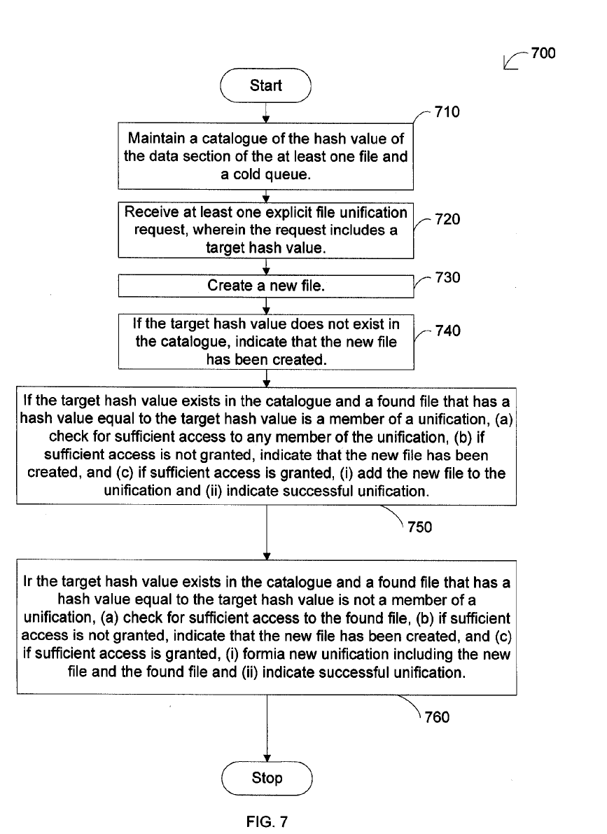

Referring to FIG. 7, in an exemplary embodiment, the present invention includes a step 710 of maintaining a catalogue of the hash value of the data section of the at least one file and a cold queue, a step 720 of receiving at least one explicit file unification request, wherein the request includes a target hash value, a step 730 of creating a new file, a step 740 of, if the target hash value does not exist in the catalogue, indicating that the new file has been created, a step 750 of, if the target hash value exists in the catalogue and a found file that has a hash value equal to the target hash value is a member of a unification, (a) checking for sufficient access to any member of the unification, (b) if sufficient access is not granted, indicating that the new file has been created, and (c) if sufficient access is granted, (i) adding the new file to the unification and (ii) indicating successful unification, and step 760 of, if the target hash value exists in the catalogue and a found file that has a hash value equal to the target hash value is not a member of a unification, (a) checking for sufficient access to the found file, (b) if sufficient access is not granted, indicating that the new file has been created, and (c) if sufficient access is granted, (i) forming a new unification including the new file and the found file and (ii) indicating successful unification.

Maintaining a Catalogue

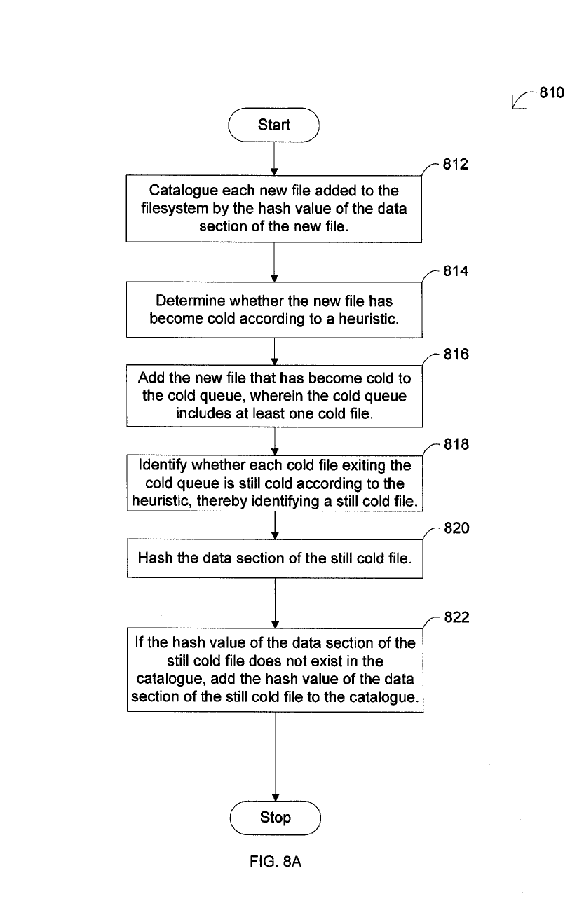

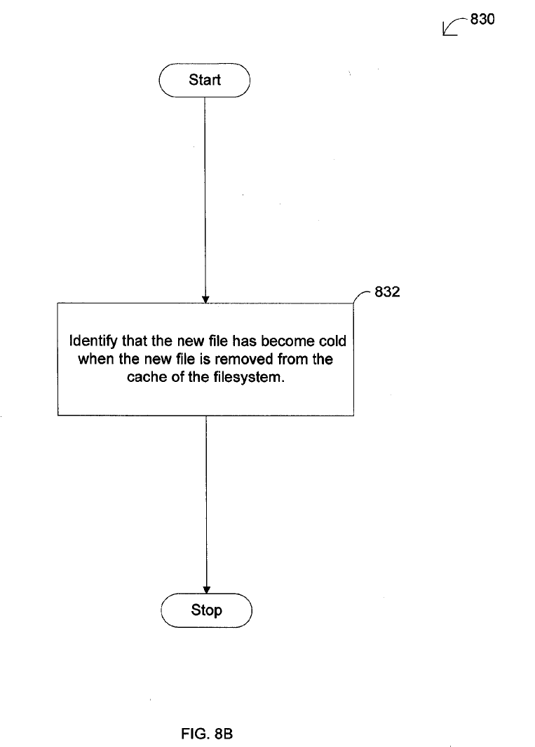

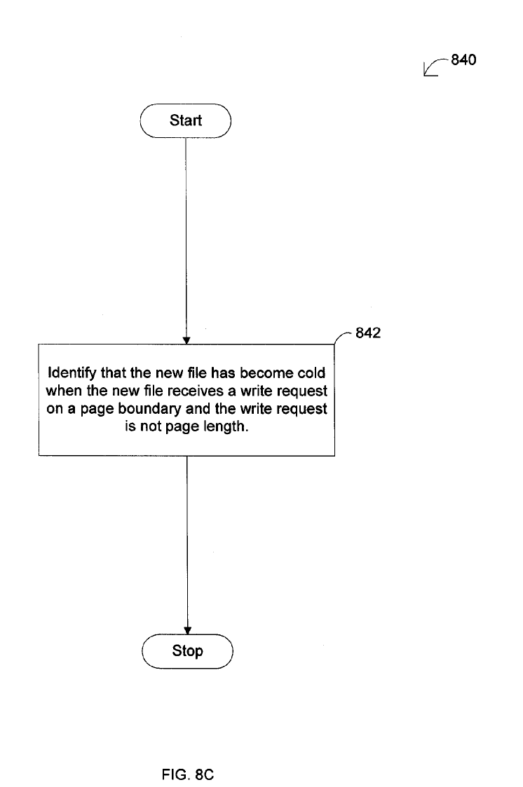

Referring next to FIG. 8A, in an exemplary embodiment, maintaining step 710 includes a step 812 of cataloguing each new file added to the filesystem by the hash value of the data section of the new file, a step 814 of determining whether the new file has become cold according to a heuristic, a step 816 of adding the new file that has become cold to the cold queue, wherein the cold queue comprises at least one cold file, a step 818 of identifying whether each cold file exiting the cold queue is still cold according to the heuristic, thereby identifying a still cold file, a step 820 of hashing the data section of the still cold file, and a step 822 of, if the hash value of the data section of the still cold file does not exist in the catalogue, adding the hash value of the data section of the still cold file to the catalogue. Referring next to FIG. 8B, in an exemplary embodiment, determining step 814 includes a step 832 of identifying that the new file has become cold when the new file is removed from the cache of the filesystem. Referring next to FIG. 8C, in an exemplary embodiment, determining step 814 includes a 342 of identifying that the new file has become cold when the new file receives a write request on a page boundary and the write request is not page length.

Adding the Cold File

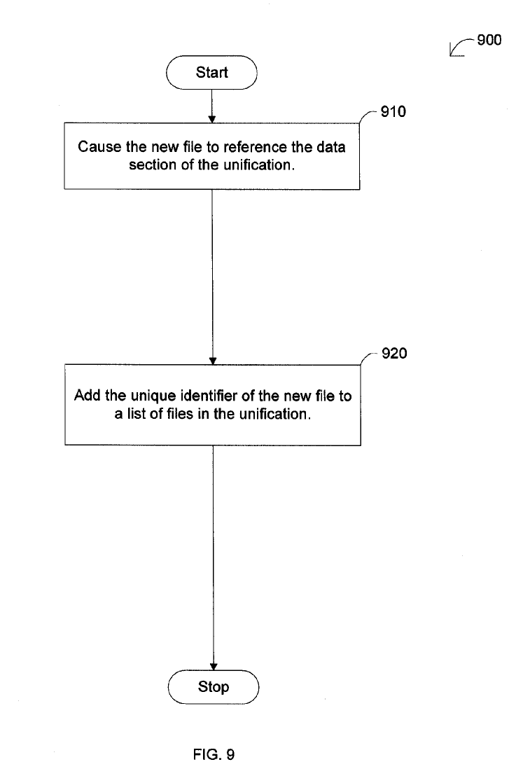

Referring next to FIG. 9, in an exemplary embodiment, the adding in step 750 includes a step 91 0 of causing the new file to reference the data section of the unification and a step 920 of adding the unique identifier of the new file to a list of files in the unification.

Forming a New Unification

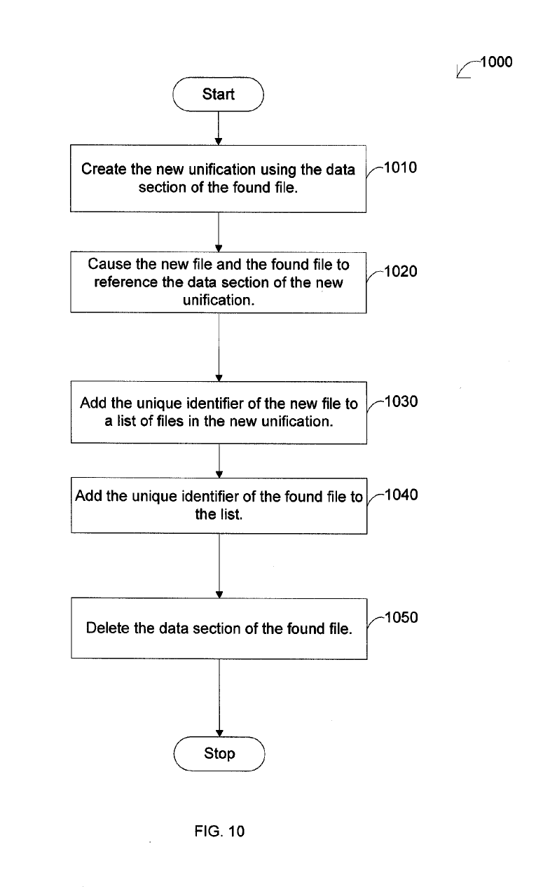

Referring next to FIG. 10, in an exemplary embodiment, the forming in step 760 includes a step 1010 of creating the new unification using the data section of the found file, a step 1020 of causing the new file and the found file to reference the data section of the new unification, a step 1030 of adding the unique identifier of the new file to a list of files in the new unification, a step 1040 of adding the unique identifier of the found file to the list, and a step 1050 of deleting the data section of the found file.

Modifying the Data Section of a Target File

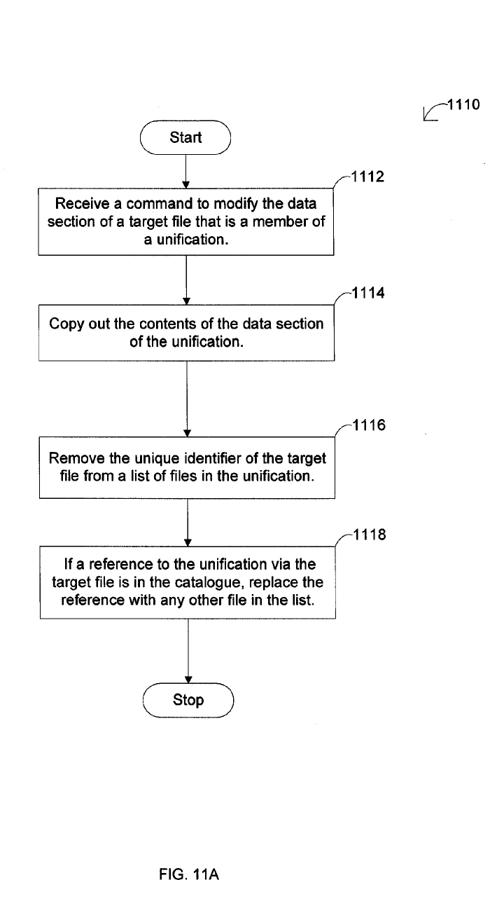

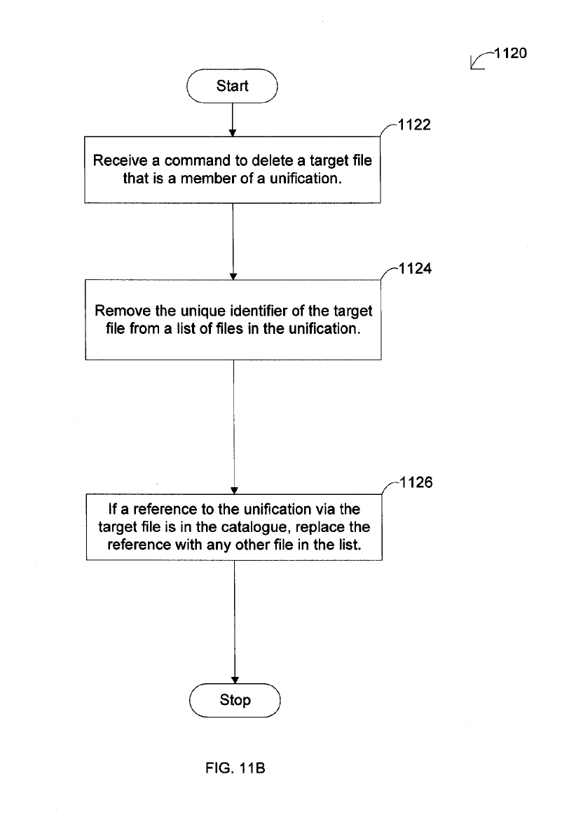

Referring next to FIG. 11A, in an exemplary embodiment, the present invention further includes a step 1112 of receiving a command to modify the data section of a target file that is a member of a unification, a step 1114 of copying out the contents of the data section of the unification, a step 1116 of removing the unique identifier of the target file from a list of files in the unification, and a step 1118 of, if a reference to the unification via the target file is in the catalogue, replacing the reference with any other file in the list.

Deleting a Target File

Referring next to FIG. 11B, in an exemplary embodiment, the present invention further includes a step 1132 of receiving a command to delete a target file that is a member of a unification, a step 1134 of removing the unique identifier of the target file from a list of files in the unification, and a step 1136 of, if a reference to the unification via the target file is in the catalogue, replacing the reference with any other file in the list.

Checking for Sufficient Access

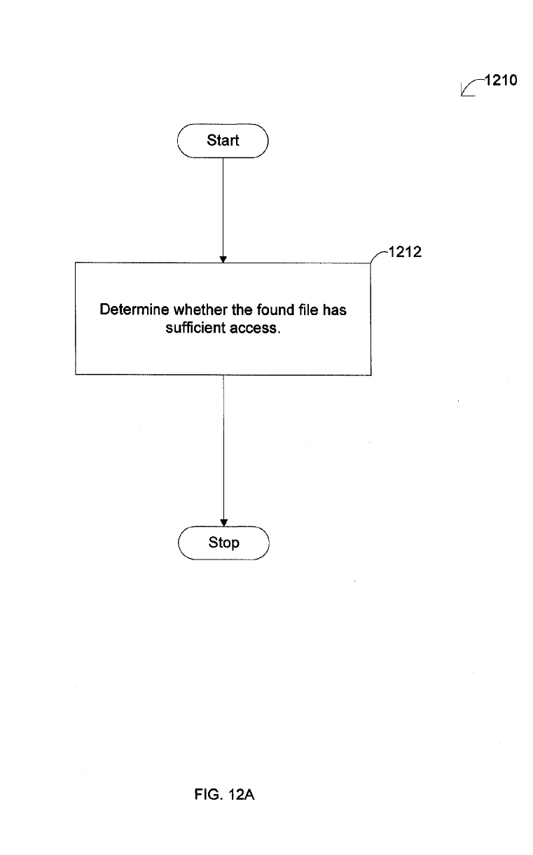

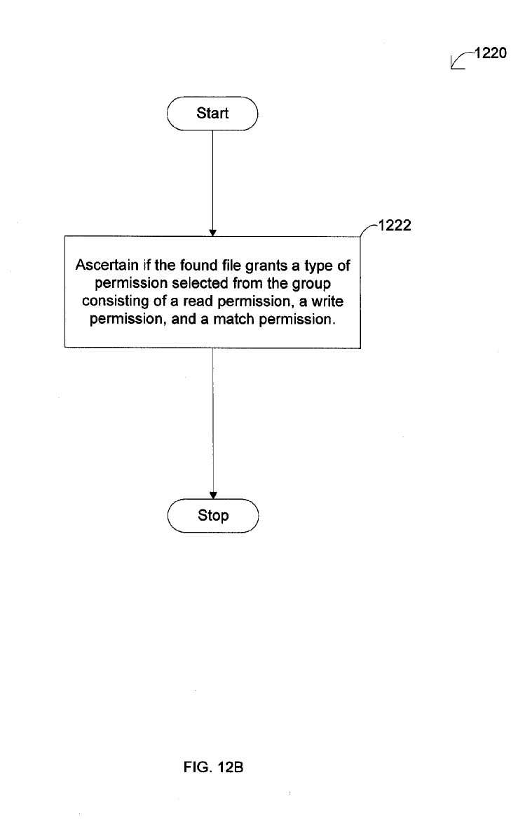

Referring next to FIG. 12A, in an exemplary embodiment, the checking in step 760 includes a step 1212 of determining whether the found file has sufficient access. Referring next to FIG. 12B, in an exemplary embodiment, determining step 1212 includes a step 1222 of ascertaining if the found file grants a type of permission selected from the group consisting of a read permission, a write permission, and a match permission.

File Identifier File Unification

In an exemplary embodiment the method and system eliminates file redundancy in a computer filesystem via file identifier file unification. In an exemplary embodiment, the method and system of eliminating file redundancy in a computer filesystem include (1) receiving at least one explicit file unification request, wherein the request includes a special file identifier, (2) searching in the filesystem for a found file that has a file identifier equal to the special file identifier, (3) if the found file does not exist, indicating that the found file does not exist, and (4) if the found file exists, (a) checking for sufficient access to the found file, (b) if sufficient access is not granted, indicating that access to the found file is denied, and (c) if sufficient access is granted, (i) creating a new file, (ii) if the found file is a member of a unification, adding the new file to the unification and indicating successful unification, and (iii) if the found file is not a member of a unification, forming a new unification including the new file and the found file and indicating successful unification.

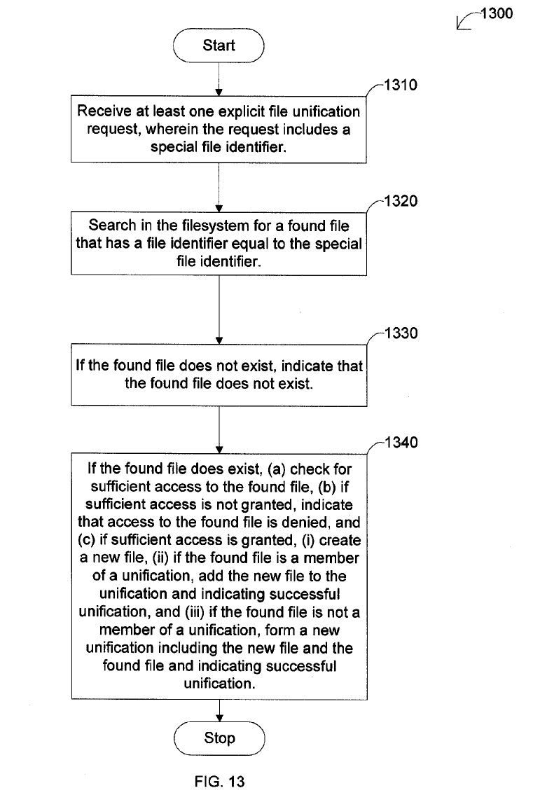

Referring to FIG. 13, in an exemplary embodiment, the present invention includes a step 1310 of receiving at least one explicit file unification request, wherein the request includes a special file identifier, a step 1320 of searching in the filesystem for a found file that has a file identifier equal to the special file identifier, a step 1330 of, if the found file does not exist, indicating that the found file does not exist, and step 1340 of, if the found file exists, (a) checking for sufficient access to the found file, (b) if sufficient access is not granted, indicating that access to the found file is denied, and (c) if sufficient access is granted, (i) creating a new file, (ii) if the found file is a member of a unification, adding the new file to the unification and indicating successful unification, and (iii) if the found file is not a member of a unification, forming a new unification including the new file and the found file and indicating successful unification.

Adding the New File

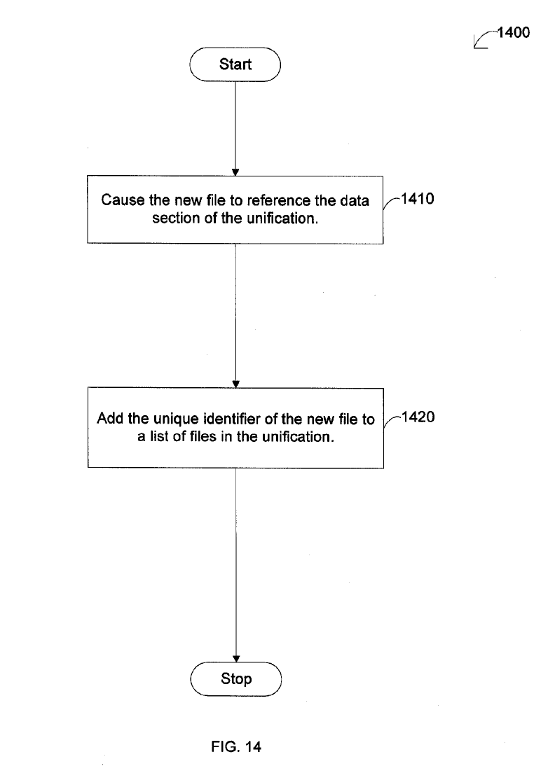

Referring next to FIG. 14, in an exemplary embodiment, the adding in step 1340 includes a step 1410 of causing the new file to reference the data section of the unification and a step 1420 of adding the unique identifier of the new file to a list of files in the unification.

Forming a New Unification

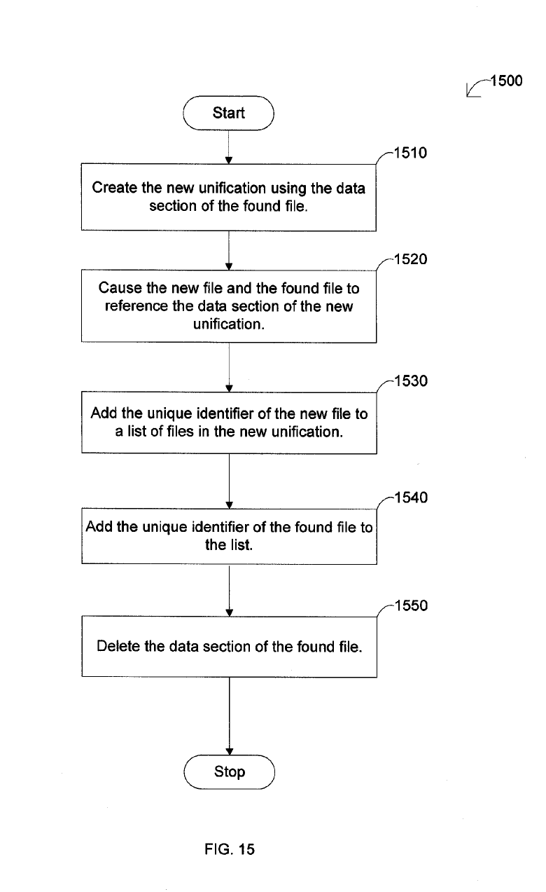

Referring next to FIG. 15, in an exemplary embodiment, the forming in step 1340 includes a step 1510 of creating the new unification using the data section of the found file, a step 1520 of causing the new file and the found file to reference the data section of the new unification, a step 1530 of adding the unique identifier of the new file to a list of files in the new unification, a step 1540 of adding the unique identifier of the found file to the list, a step 1550 deleting the data section of the found file.

Modifying the Data Section of a Target File

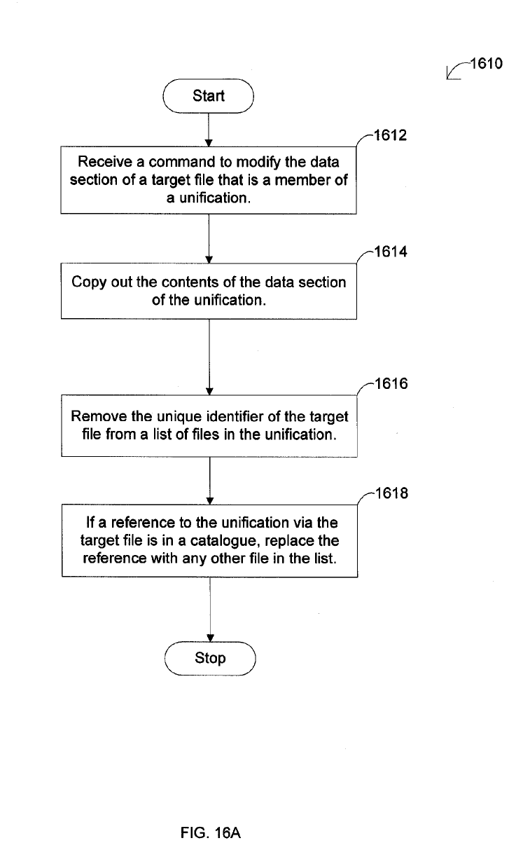

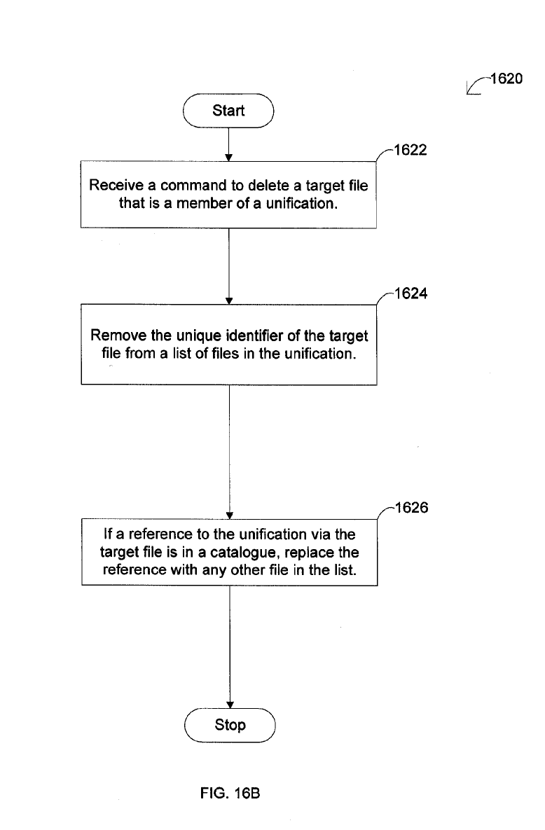

Referring next to FIG. 16A, in an exemplary embodiment, the present invention further includes a step 1612 of receiving a command to modify the data section of a target file that is a member of a unification, a step 1614 of copying out the contents of the data section of the unification, a step 1616 of removing the unique identifier of the target file from a list of files in the unification, and a step 1618 of, if a reference to the unification via the target file is in a catalogue, replacing the reference with any other file in the list.

Deleting a Target File

Referring next to FIG. 16B, in an exemplary embodiment, the present invention further includes a step 1622 of receiving a command to delete a target file that is a member of a unification, a step 1624 of removing the unique identifier of the target file from a list of files in the unification, and a step 1626 of, if a reference to the unification via the target file is in a catalogue, replacing the reference with any other file in the list.

Checking for Sufficient Access

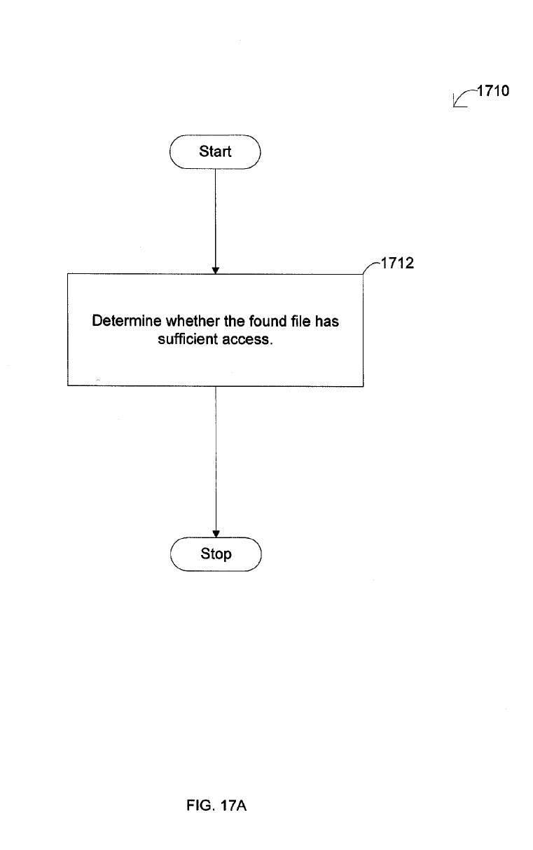

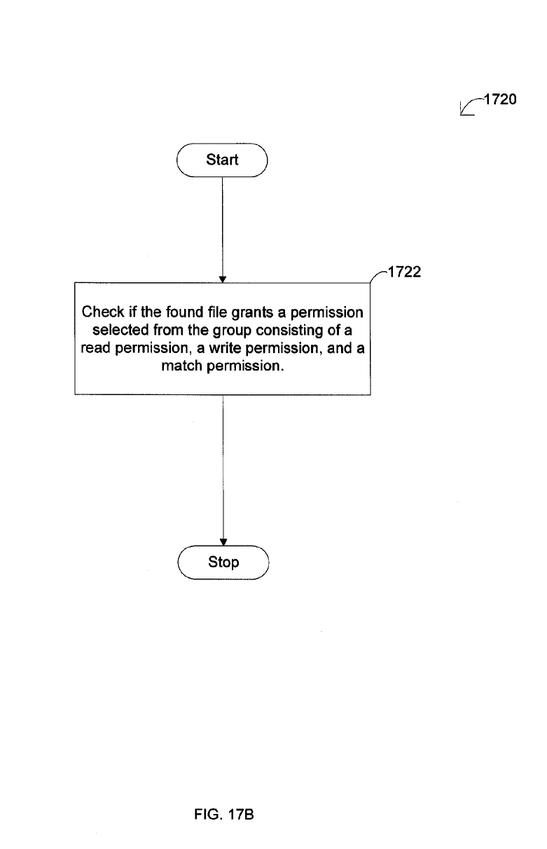

Referring next to FIG. 17A, in an exemplary embodiment, checking step 1340 includes a step 1712 of determining whether the found file has sufficient access. Referring next to FIG. 17B, in an exemplary embodiment, determining step 1712 includes a step 1722 of checking if the found file grants a permission selected from the group consisting of a read permission, a write permission, and a match permission.

Establishing Match Permission

The present invention also provides a method and system of establishing match permission for at least one computer file in a computer filesystem. In an exemplary embodiment, the method and system include (1) granting a permission to match the data section of the file and (2) permitting a one-way, collision resistant hash of the data section of the file to be exposed based on the permission.

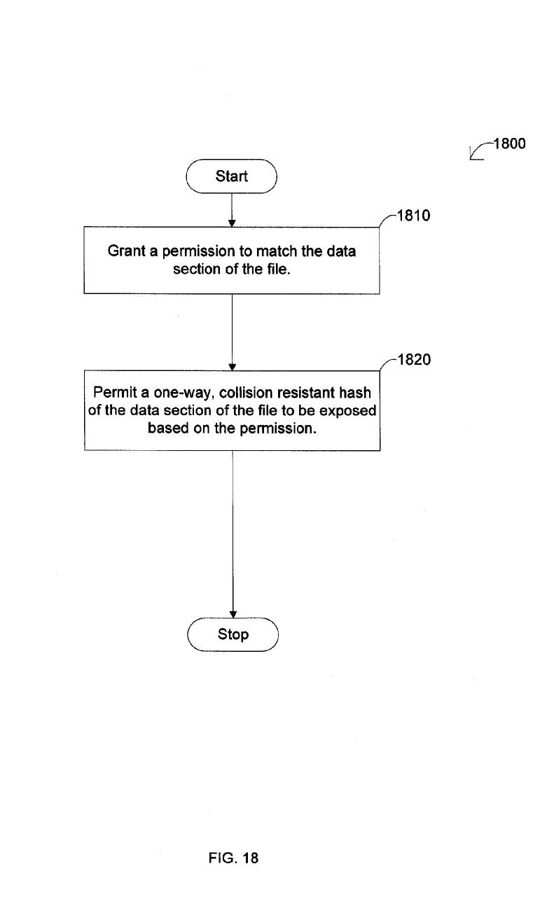

Referring to FIG. 18, in an exemplary embodiment, the present invention includes a step 1810 of granting a permission to match the data section of the file and a step 1820 of permitting a one-way, collision resistant hash of the data section of the file to be exposed based on the permission.

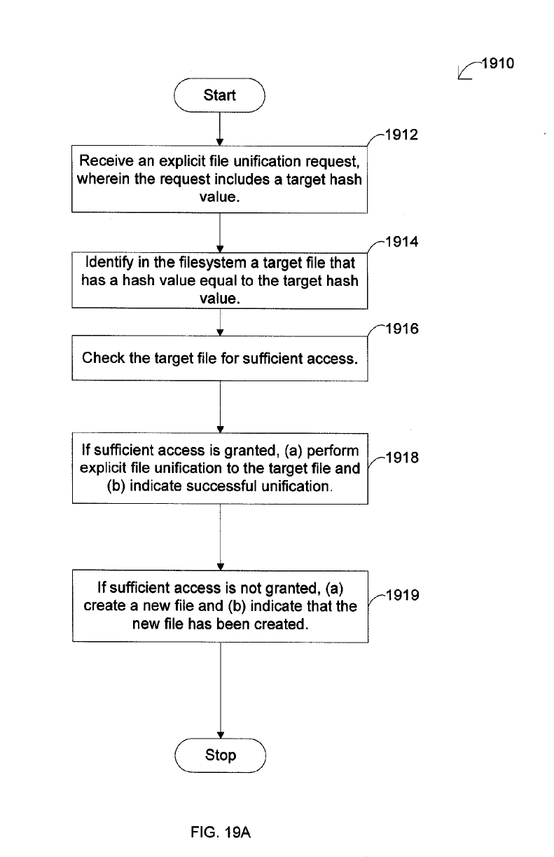

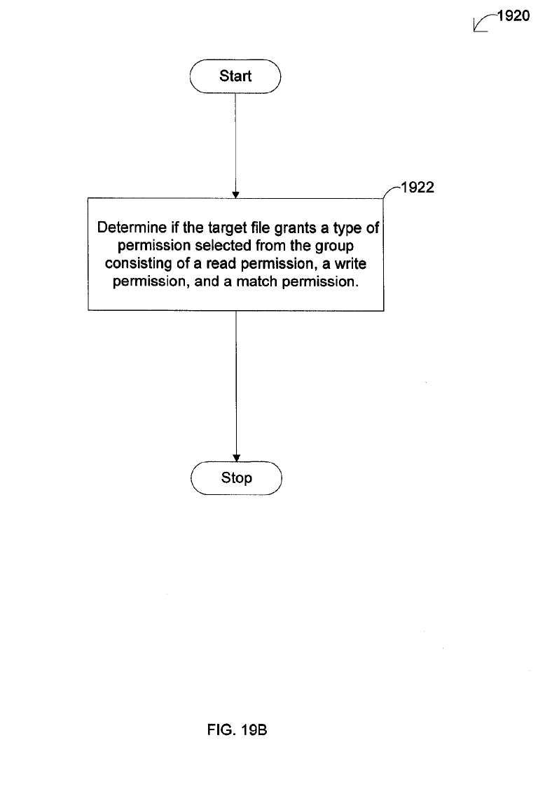

Referring next to FIG. 19A, in an exemplary embodiment, the present invention further includes a step 1912 of receiving an explicit file unification request, wherein the request includes a target hash value, a step 1914 of identifying in the filesystem a target file that has a hash value equal to the target hash value, a step 1916 of checking the target file for sufficient access, a step 1918 of, if sufficient access is granted, (a) performing explicit file unification to the target file and (b) indicating successful unification, and a step 1919 of, if sufficient access is not granted, (a) creating a new file and (b) indicating that the new file has been created. Referring next to FIG. 19B, in an exemplary embodiment, checking step 1916 includes a step 1922 of determining if the target file grants a type of permission selected from the group consisting of a read permission, a write permission, and a match permission.

Conclusion

Having fully described a preferred embodiment of the invention and various alternatives, those skilled in the art will recognize, given the teachings herein, that numerous alternatives and equivalents exist which do not depart from the invention. It is therefore intended that the invention not be limited by the foregoing description, but only by the appended claims.

What is claimed is:

1. A method of eliminating file redundancy for at least one computer file in a computer filesystem, the method comprising:
maintaining a catalogue of the hash value of the data section of the at least one file and a cold queue;
if a cold file that exits the cold queue is not added to the catalogue and if a found file that has a hash value equal to the hash value of the cold file is a member of a unification, adding the cold file to the unification; and
if a cold file that exits the cold queue is not added to the catalogue and if a found file that has a hash value equal to the hash value of the cold file is not a member of a unification, creating a new unification comprising the cold file and the found file.

2. The method of claim 1 wherein the maintaining comprises:
cataloguing each new file added to the filesystem by the hash value of the data section of the new file;
determining whether the new file has become cold according to a heuristic;
adding the new file that has become cold to the cold queue, wherein the cold queue comprises at least one cold file;
identifying whether each cold file exiting the cold queue is still cold according to the heuristic, thereby identifying a still cold file;
hashing the data section of the still cold file; and
if the hash value of the data section of the still cold file does not exist in the catalogue, adding the hash value of the data section of the still cold file to the catalogue.

3. The method of claim 2 wherein the determining comprises identifying that the new file has become cold when the new file is removed from the cache of the filesystem.

4. The method of claim 2 wherein the determining comprises identifying that the new file has become cold when the new file receives a write request on a page boundary and the write request is not page length.

5. The method of claim 1 wherein the adding comprises:
causing the cold file to reference the data section of the unification;
adding the unique identifier of the cold file to a list of files in the unification; and
deleting the data section of the cold file.

6. The method of claim 1 wherein the creating comprises:
creating the new unification using the data section of the found file;
causing the cold file and the found file to reference the data section of the new unification;
adding the unique identifier of the cold file to a list of files in the new unification;
adding the unique identifier of the found file to the list of files;
deleting the data section of the cold file; and
deleting the data section of the found file.

7. The method of claim 1 further comprising;
receiving a request to modify the data section of a target file that is a member of a unification;
copying out the contents of the data section of the unification;
removing the unique identifier of the target file from a list of files in the unification; and
if a reference to the unification via the target file is in the catalogue, replacing the reference with any other file in the list.

8. The method of claim 1 further comprising:
receiving a request to delete a target file that is a member of a unification; removing the unique identifier of the target file from a list of files in the unification; and
if a reference to the unification via the target file is in the catalogue, replacing the reference with any other file in the list.

9. A method of eliminating file redundancy for at least one computer file in a computer filesystem, the method comprising:
maintaining a catalogue of the hash value of the data section of the at least one file and a cold queue;
receiving at least one explicit file unification request, wherein the request comprises a target hash value;
creating a new file;
if the target hash value does not exist in the catalogue, indicating that the new file has been created;
if the target hash value exists in the catalogue and a found file that has a hash value equal to the target hash value is a member of a unification,
checking for sufficient access to any member of the unification,
if sufficient access is not granted, indicating that the new file has been created, and
if sufficient access is granted,
adding the new file to the unification and
indicating successful unification; and
if the target hash value exists in the catalogue and a found file that has a hash value equal to the target hash value is not a member of a unification,
checking for sufficient access to the found file,
if sufficient access is not granted, indicating that the new file has been created, and
if sufficient access is granted,
forming a new unification comprising the new file and the found file and
indicating successful unification.

10. The method of claim 9 wherein the maintaining comprises:
cataloguing each new file added to the filesystem by the hash value of the data section of the new file;
determining whether the new file has become cold according to a heuristic;
adding the new file that has become cold to the cold queue, wherein the cold queue comprises at least one cold file;
identifying whether each cold file exiting the cold queue is still cold according to the heuristic, thereby identifying a still cold file;
hashing the data section of the still cold file; and
if the hash value of the data section of the still cold file does not exist in the catalogue, adding the hash value of the data section of the still cold file to the catalogue.

11. The method of claim 10 wherein the determining comprises identifying that the new file has become cold when the new file is removed from the cache of the filesystem.

12. The method of claim 10 wherein the determining comprises identifying that the new file has become cold when the new file receives a write request on a page boundary and the write request is not page length.

13. The method of claim 9 wherein the adding comprises:
causing the new file to reference the data section of the unification; and
adding the unique identifier of the new file to a list of files in the unification.

14. The method of claim 9 wherein the forming comprises:
creating the new unification using the data section of the found file;
causing the new file and the found file to reference the data section of the new unification;
adding the unique identifier of the new file to a list of files in the new unification;
adding the unique identifier of the found file to the list; and
deleting the data section of the found file.

15. The method of claim 9 further comprising:
receiving a command to modify the data section of a target file that is a member of a unification;
copying out the contents of the data section of the unification;
removing the unique identifier of the target file from a list of files in the unification; and
if a reference to the unification via the target file is in the catalogue, replacing the reference with any other file in the list.

16. The method of claim 9 further comprising:
receiving a command to delete a target file that is a member of a unification;
removing the unique identifier of the target file from a list of files in the unification; and
if a reference to the unification via the target file is in the catalogue, replacing the reference with any other file in the list.

17. The method of claim 9 wherein the checking comprises determining whether the found file has sufficient access.

18. The method of claim 17 wherein the determining comprises ascertaining if the found file grants a type of permission selected from the group consisting of a read permission, a write permission, and a match permission.

19. A method of eliminating file redundancy in a computer filesystem, the method comprising:
receiving at least one explicit file unification request, wherein the request comprises a special file identifier;
searching in the filesystem for a found file that has a file identifier equal to the special file identifier;
if the found file does not exist, indicating that the found file does not exist; and
if the found file exists,
checking for sufficient access to the found file,
if sufficient access is not granted, indicating that access to the found file is denied, and
if sufficient access is granted,
creating a new file,
if the found file is a member of a unification, adding the new file to the unification and indicating successful unification, and
if the found file is not a member of a unification,
forming a new unification comprising the new file and the found file and
indicating successful unification.

20. The method of claim 19 wherein the adding comprises:
causing the new file to reference the data section of the unification; and
adding the unique identifier of the new file to a list of files in the unification.

21. The method of claim 19 wherein the forming comprises:
creating the new unification using the data section of the found file;
causing the new file and the found file to reference the data section of the new unification;
adding the unique identifier of the new file to a list of files in the new unification;
adding the unique identifier of the found file to the list; and
deleting the data section of the found file.

22. The method of claim 19 further comprising:
receiving a command to modify the data section of a target file that is a member of a unification;
copying out the contents of the data section of the unification;
removing the unique identifier of the target file from a list of files in the unification; and
if a reference to the unification via the target file is in a catalogue, replacing the reference with any other file in the list.

23. The method of claim 19 further comprising:
receiving a command to delete a target file that is a member of a unification;
removing the unique identifier of the target file from a list of files in the unification; and
if a reference to the unification via the target file is in a catalogue, replacing the reference with any other file in the list.

24. The method of claim 19 wherein the checking comprises determining whether the found file has sufficient access.

25. The method of claim 24 wherein the determining comprises checking if the found file grants a permission selected from the group consisting of a read permission, a write permission, and a match permission.

26. A method of establishing match permission for at least one computer file in a computer filesystem, the method comprising:
granting a permission to match the data section of the file; and
permitting a one-way, collision resistant hash of the data section of the file to be exposed based on the permission.

27. The method of claim 26 further comprising:
receiving an explicit file unification request, wherein the request comprises a target hash value;
identifying in the filesystem a target file that has a hash value equal to the target hash value;
checking the target file for sufficient access;
if sufficient access is granted,
performing explicit file unification to the target file and
indicating successful unification; and
if sufficient access is not granted,
creating a new file and
indicating that the new file has been created.

28. The method of claim 27 wherein the checking comprises determining if the target file grants a type of permission selected from the group consisting of a read permission, a write permission, and a match permission.

29. A system of eliminating file redundancy for at least one computer file in a computer filesystem, the system comprising:
a maintaining module configured to maintain a catalogue of the hash value of the data section of the at least one file and a cold queue;
an adding module configured to, if a cold file that exits the cold queue is not added to the catalogue and if a found file that has a hash value equal to the hash value of the cold file is a member of a unification, add the cold file to the unification; and
a creating module configured to, if a cold file that exits the cold queue is not added to the catalogue and if a found file that has a hash value equal to the hash value of the cold file is not a member of a unification, create a new unification comprising the cold file and the found file.

30. The system of claim 29 wherein the maintaining module comprises:
a cataloguing module configured to catalogue each new file added to the filesystem by the hash value of the data section of the new file;
a determining module configured to determine whether the new file has become cold according to a heuristic;
an adding module configured to add the new file that has become cold to the cold queue, wherein the cold queue comprises at least one cold file;
an identifying module configured to identify whether each cold file exiting the cold queue is still cold according to the heuristic, thereby identifying a still cold file;
a hashing module configured to hash the data section of the still cold file; and
an adding module configured to, if the hash value of the data section of the still cold file does not exist in the catalogue, add the hash value of the data section of the still cold file to the catalogue.

31. The system of claim 30 wherein the determining module comprises an identifying module configured to identify that the new file has become cold when the new file is removed from the cache of the filesystem.

32. The system of claim 30 wherein the determining module comprises an identifying module configured to identify that the new file has become cold when the new file receives a write request on a page boundary and the write request is not page length.

33. The system of claim 29 wherein the adding module comprises:
a causing module configured to cause the cold file to reference the data section of the unification;
an adding module configured to add the unique identifier of the cold file to a list of files in the unification; and
a deleting module configured to delete the data section of the cold file.

34. A computer program product usable with a programmable computer having readable program code embodied therein of eliminating file redundancy for at least one computer file in a computer filesystem, the computer program product comprising:
computer readable code for maintaining a catalogue of the hash value of the data section of the at least one file and a cold queue;
computer readable code for, if a cold file that exits the cold queue is not added to the catalogue and if a found file that has a hash value equal to the hash value of the cold file is a member of a unification, adding the cold file to the unification; and
computer readable code for, if a cold file that exits the cold queue is not added to the catalogue and if a found file that has a hash value equal to the hash value of the cold file is not a member of a unification, creating a new unification comprising the cold file and the found file.

35. The computer program product of claim 34 wherein the computer readable code for maintaining comprises:
computer readable code for cataloguing each new file added to the filesystem by the hash value of the data section of the new file;
computer readable code for determining whether the new file has become cold according to a heuristic;
computer readable code for adding the new file that has become cold to the cold queue, wherein the cold queue comprises at least one cold file;
computer readable code for identifying whether each cold file exiting the cold queue is still cold according to the heuristic, thereby identifying a still cold file;
computer readable code for hashing the data section of the still cold file; and
computer readable code for, if the hash value of the data section of the still cold file does not exist in the catalogue, adding the hash value of the data section of the still cold file to the catalogue.
